(19) United States
(12) Patent Application Publication
(10) Pub. No.: US 2026/0188039 A1
(43) Pub. Date: Jul. 2, 2026

(54) DATE RECOGNITION METHOD, APPARATUS, READABLE MEDIUM AND ELECTRONIC DEVICE

(71) Applicant: BEIJING YOUZHUJU NETWORK TECHNOLOGY CO., LTD., Beijing (CN)

(72) Inventors: Guanyu DENG, Beijing (CN); Lulu CHEN, Beijing (CN); Can HUANG, Beijing (CN); Changhu WANG, Beijing (CN)

(21) Appl. No.: 18/729,043

(22) PCT Filed: Jan. 4, 2023
(86) PCT No.: PCT/CN2023/070269

§ 371 Date: Jul. 15, 2024

(30) Foreign Application Priority Data
Jan. 29, 2022 (CN) 202210113138.7

(51) Int. Cl. G06V 30/416; G06V 10/764; G06V 30/10; G06V 30/19

(52) U.S. Cl. CPC G06V 30/416; G06V 10/764; G06V 30/10; G06V 30/19173

(57) ABSTRACT

The present disclosure relates to a date recognition method, apparatus, readable medium and electronic device. The method recognizes the undetermined date corresponding to the date text through the predetermined date recognition model, and obtains the target entity category corresponding to each character in the date text. Determine the target date corresponding to the date text according to the target entity category corresponding to each character in the date text and the undetermined date. The target entity category is used to characterize whether the character is a specified character related to a date number, and in response to the character being a specified character related to a date number, the character corresponding to the position information of the number in the date. It is able to recognize the date in various date recognition scenarios effectively. It is also able to effectively ensure the accuracy of date recognition results. Thereby effectively ensuring the recognition rate of the date to be recognized, and also effectively improving the reliability of the date recognition results.

This disclosure requests the priority of the Chinese patent application number “202210113138.7” submitted on Jan. 29, 2022, with the application name “Date Recognition Method, Apparatus, Readable Medium and Electronic Device”, and all the Chinese patent applications contents are incorporated by reference into this disclosure.

### FIELD

The present disclosure relates to computer field, specifically, to a date recognition method, device, readable medium and electronic equipment.

### BACKGROUND

With the development of science and technology, human beings have gradually applied computer vision technology more and more widely. OCR (Optical Character Recognition, optical character recognition) character recognition is an important branch of computer vision technology. After completing OCR character recognition, it is often accompanied by extraction of key information in recognition text, for example, extraction of date information in recognition text.

Current date recognition methods can usually achieve effective recognition only for simple date text recognition scenarios (for example, date recognition scenarios such as invoices, train tickets, documents, etc.), but for relatively complex date text recognition scenarios (such as recognition for date text in OCR character recognition results), there is a problem of low recognition rate and poor accuracy of recognition results.

### SUMMARY

This summary section is provided to introduce in brief form the ideas that are described in detail in the detailed description section that follows. This summary section is not intended to identify key features or essential features of the claimed technical solution, nor is it intended to be used to limit the scope of the claimed technical solution.

The present disclosure provides a date recognition method, apparatus, readable medium and electronic device.

In a first aspect, the present disclosure provides a date recognition method, which comprises:
obtaining text to be recognized, the text to be recognized comprising date text; and
inputting the text to be recognized into a predetermined date recognition model to obtain a target date output by the predetermined date recognition model;
wherein, the predetermined date recognition model is used to: recognize an undetermined date corresponding to the date text; obtain a target entity category corresponding to each character in the date text; determine a target date corresponding to the date text according to a target entity category corresponding to each of character in the date text and the undetermined date, the target entity category being used to characterize whether the character is a specified character related to a date number; and in response to the character being a specified character related to a date number, the character corresponding to position information of the number in the date.

In a second aspect, the present disclosure provides a date recognition device, which comprises:
a first obtaining module, configured to obtain text to be recognized, the text to be recognized comprising date text;
a second obtaining module, configured to input the text to be recognized into a predetermined date recognition model to obtain a target date output through the predetermined date recognition model;
wherein, the predetermined date recognition model is used to recognize a undetermined date corresponding to the date text, obtaining a target entity category corresponding to each character in the date text, determining a target date corresponding to the date text according to a target entity category corresponding to each character in the date text and the undetermined date, the target entity category being used to characterize whether the character being a specified character related to a date number, and in response to the character being a specified character related to a date number, the character corresponding to position information of a number in a date.

In a third aspect, the present disclosure relates to a computer-readable medium having a computer program stored thereon, wherein steps of the method described in the first aspect are implemented in response to the program being executed by a processing device.

In a fourth aspect, the present disclosure provides an electronic device, comprising:
a storage device having a computer program stored thereon;
a processing device, configured to execute the computer program in the storage device to implement steps of the method in the first aspect.

The above technical solution recognizes the undetermined date corresponding to the date text through the predetermined date recognition model, obtaining the target entity category corresponding to each character in the date text, and determining the target entity date corresponding to the date text according to the target entity category corresponding to each character in the date text and the undetermined date, the target entity category being used to characterize whether the character being a specified character related to a date number and in response to the character being a specified character related to a date number, the character corresponding to position information of a number in a date. In this way, by determining the target date corresponding to the date text according to the target entity category corresponding to each character in the date text and the undetermined date, it is able to recognize the target date in the text to be recognized effectively and accurately. hereby effectively ensuring the recognition rate of the date in the text to be recognized, and also effectively improving the reliability of the date recognition results.

Other features and advantages of the present disclosure will be detailed in the detailed description section that follows.

### BRIEF DESCRIPTION OF THE DRAWINGS

The above and other features, advantages and aspects of various embodiments of the present disclosure will become more apparent with reference to the following detailed description in conjunction with the accompanying drawings. Throughout the drawings, the same or similar reference numbers refer to the same or similar elements. It is to be understood that the drawings are schematic and that elements and elements are not necessarily drawn to scale. In the attached drawings:

FIG. 1 is a flow chart of a date recognition method illustrating an exemplary embodiment of the present disclosure;

FIG. 2 is a structural block diagram of a predetermined date recognition model illustrating an exemplary embodiment of the present disclosure;

FIG. 3 is a flow chart of a date recognition method according to the embodiments shown in FIG. 1 according to the present disclosure;

FIG. 4 is a flow chart of a training method for a predetermined date recognition model illustrating an exemplary embodiment of the present disclosure;

FIG. 5 is a block diagram of a date recognition device illustrating an exemplary embodiment of the present disclosure;

FIG. 6 is a block diagram of an electronic device showing an exemplary embodiment of the present disclosure.

### DETAILED DESCRIPTION

Embodiments of the present disclosure will be described in more detail below with reference to the accompanying drawings. Although certain embodiments of the disclosure are shown in the drawings, it should be understood that the disclosure may be embodied in various forms and should not be construed as limited to the embodiments set forth herein, but rather these embodiments are provided for understanding this disclosure thoroughly and clearly. It should be understood that the drawings and embodiments of the present disclosure are for illustrative purposes only and are not intended to limit the scope of the present disclosure.

It should be understood that various steps described in the method embodiment of the present disclosure may be executed in different orders and/or in parallel. Furthermore, method embodiments may comprise additional steps and/or omit performance of illustrated steps. The scope of the present disclosure is not limited in this regard.

As used herein, the term “include” and its variations are open-ended, i.e. “including but not limited to.” The term “based on” means “based at least in part on.” The term “an embodiment” means “at least one embodiment”; the term “another embodiment” means “at least one further embodiment”; the term “some embodiments” means “at least some embodiments”. Relevant definitions of other terms will be given in the description below.

It should be noted that concepts such as “first” and “second” mentioned in this disclosure are only used to distinguish different apparatus, modules or units, and are not used to limit the order of functions performed by these apparatus, modules, or units, or the dependence relationship between these apparatus, modules or units.

It should be noted that the modifications of “one” and “plurality” mentioned in this disclosure are illustrative and not restrictive. Those skilled in the art will understand that unless the context clearly indicates otherwise, it should be understood as “one or Multiple”.

The names of messages or information exchanged between a plurality of devices in the embodiments of the present disclosure are for illustrative purposes only and are not used to limit the scope of these messages or information.

Before introducing the DETAILED DESCRIPTION of the present disclosure in detail, the application scenarios of the present disclosure are first described below. The present disclosure can be applied to the recognition process of dates in images, documents (PDF documents, Word documents), or bills (for example, invoices, train tickets). Most of the current date recognition methods are based on specialized date recognition models trained for specific recognition scenarios. For example, in related technologies, specialized models are trained for the recognition of dates in train tickets or recognition of dates in invoices. Since these specialized models are usually designed for a single scenario, usually the generalization capability of the model is poor. These models cannot be universal and cannot effectively recognize dates in other date recognition scenarios effectively. They cannot guarantee the accuracy of date recognition results, which is not conducive to improvement date recognition rate.

In order to solve the above technical problems, the present disclosure provides a date recognition method, apparatus, readable medium and electronic device. The method uses the predetermined date recognition model to recognize the undetermined date corresponding to the date text, and obtains each character in the date text, determining the target date corresponding to the date text according to the target entity category corresponding to each character in the date text and the undetermined date. The target entity category is used to characterize whether the character is a specified character related to a date number, and in response to the character being a specified character related to a date number, the position information of the corresponding number in the date can be effectively recognized for dates in a variety of date recognition scenarios, and can also effectively ensure the accuracy of date recognition results, which can not only effectively ensure the date recognition rate, but also effectively improve the reliability of date recognition results.

The technical solution of the present disclosure will be described in detail below in conjunction with specific embodiments.

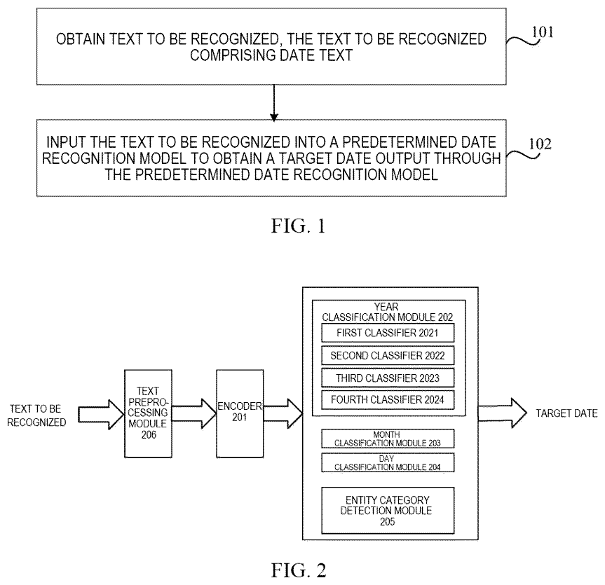

FIG. 1 is a flow chart of a date recognition method illustrating an exemplary embodiment of the present disclosure; as shown in FIG. 1, the method may comprise the following steps:

Step 101: Obtaining text to be recognized, the text to be recognized comprising date text.

Wherein the text to be recognized may be the target text obtained after OCR character recognition of the image. For example, it may be the character text obtained after OCR recognition of a scanned copy of a paper document, or it may be a certain piece of text in a WORD file or the text corresponding to the electronic bill.

Step 102: Inputting the text to be recognized into a predetermined date recognition model to obtain the target date output by the predetermined date recognition model.
wherein, the predetermined date recognition model is used to: recognize an undetermined date corresponding to the date text; obtain a target entity category corresponding to each character in the date text; determine a target date corresponding to the date text according to a target entity category corresponding to each of character in the date text and the undetermined date, the target entity category being used to characterize whether the character is a specified character related to a date number; and in response to the character being a specified character related to a date number, the character corresponding to position information of the number in the date.

For example, the target entity category may be “other”, “year-start”, “year-mid”, “year-end”, “month-start”, “month-end”, “month-single”, “day-start”, “day-end” or “day-single”. The “other” characterizes that the character is a specified character not related to date numbers. The “year-start” characterizes the first number in the year data. The “year-end” characterizes the last number in the year data. The “year-mid” characterizes other number s in the year data except the first and last number s of the year. For example, if the year data is “2018”, then the target entity category corresponding to the first number “2” (i.e., the first number from left to right in the year data) is “year-start”, and the target entity category corresponding to “8” (i.e., the last number from left to right in the year data) is “year-end”. The target entity category corresponding to “0” and “1” is “year-mid”. The “month-start” characterizes the first number in the month data in response to the month data being two digits, and the “month-end” characterizes the second number in the month data in response to the month data being two digits. The “month-single” characterizes the month data being a one-digit number. For example, in response to the month data being “12”, the target entity category corresponding to the “1” is “month-start”, and the target entity category corresponding to the “2” is “month-end”. In response to the month data being “04”, the target entity category corresponding to the “0” is “month-start”, and the target entity category corresponding to the “4” is “month-end”. In response to the month data being “3”, the target entity category corresponding to the “3” is “month-single”. The “day-start” characterizes the first number in the day data in response to the day data in the date being two digits, and the “day-end” characterizes the second digit in the day data in response to the day data in the date being two digits. The “day-single” characterizes that the day data being a one-digit number. For example, in response to the day data being “26”, the target entity category corresponding to the “2” is “day-start”, and the target entity category corresponding to “6” is “day-end”. In response to the day data being “05”, the target entity category corresponding to “0” is “day-start”, and the target entity category corresponding to “5” is “day-end”. In response to the day data being “7”, the target entity category corresponding to the “7” is “day-single”.

The above-described method of determining the target date corresponding to the date text according to the target entity category corresponding to each character in the date text and the undetermined date may comprises:

obtaining the specified entity category corresponding to each number in the undetermined date; in response to the specified entity category corresponding to each number in the undetermined date being in consistent with the target entity category of a character corresponding to the number in the date text, determining the undetermined date as the target date.

It should be noted that in response to obtaining the specified entity category corresponding to each number in the undetermined date, a possible embodiment method is: determining the specified entity category corresponding to the number according to the position of each number in the undetermined date. For example, in response to the format of the undetermined date being “undetermined year-undetermined month-undetermined day”, and the number is the data before the first “-”, then it is determined that the number belongs to the number in the undetermined year. In response to the number being the first number in the number of the undetermined year, determines the specified entity category corresponding to the number as “year-start”. In response to the number being the last number in the number of the undetermined year, determines the specified entity category corresponding to the number as “year-end”. In response to the number belonging to the undetermined the year data, but not being the first number of the undetermined year number, nor being the last number of the undetermined year number, then it is determined that the specified entity category corresponding to this number is “year-mid”. In response to the number being the data between two “-” s, it is determined that the number belongs to a number in an undetermined month. In response to determining that the undetermined month only comprises one digit, it is determined that the specified entity category of the number corresponding to the undetermined month is “month-single”. In response to the undetermined month comprises two digits, if the number is the first number in the undetermined month, then it is determined that the specified entity category corresponding to this number is “month-start”. If the number is the second number of the undetermined month, then it is determined that the specified entity category corresponding to the number is “month-end”. In response to the number being the data after the second “-”, it is determined that the number belongs to the number corresponding to the undetermined day. In response to determining that the undetermined day only comprises one digit, it is determined that the specified entity category of the number corresponding to the undetermined day is “day-single”. In response to determining that the undetermined month comprises two digits, if the number is the first number of the undetermined day, then it is determined that the specified entity category corresponding to the number is “day-start”, if the number is the second number of the undetermined day, then it is determined that the specified entity category corresponding to this number is “day-end”.

Another possible embodiment is: inputting the undetermined date into a predetermined naming entity category recognition model, to cause the predetermined naming entity recognition model to output a specified named entity corresponding to each number in the undetermined date. The specified named entity may be one of “others”, “year-start”, “year-mid”, “year-end”, “month-start”, “month-end”, “month-single”, “day-start”, “day-end” and “day-single”. The predetermined naming entity recognition model may be a neural network model or other machine learning model.

The above technical solution, since the text to be recognized may be the text obtained by OCR character recognition, or it may be the text in other documents, or it may be the text corresponding to the bill, thus it is able to ensure effective recognition of dates in a variety of date recognition scenarios, and it is also able to effectively ensure the accuracy of date recognition results, thereby not only effectively ensuring the date recognition rate, but also effectively improving the reliability of date recognition results.

FIG. 2 is a structural block diagram of a predetermined date recognition model illustrating an exemplary embodiment of the present disclosure. As shown in FIG. 2, the predetermined date recognition model comprises an encoder 201 and a year classification module 202 coupled with the encoder 201, month classification module 203, day classification module 204 and character entity category detection module 205;

The year classification module 202 is used to recognize the undetermined year in the date text. The year classification module comprises a plurality of classifiers, and different classifiers are used to recognize numbers at different positions in the undetermined year;

The month classification module 203 is used to recognize the undetermined month in the date text;

The day classification module 204 is used to recognize the undetermined day in the date text;

The character entity category detection module 205 is used to obtain the target entity category corresponding to each character in the date text.

Wherein, the encoder 201 may be a BERT (Bidirectional Encoder Representation from Transformers, Bidirectional Encoder Representation) encoder. The predetermined date recognition model may also comprise a text preprocessing module 206. The output end of the text preprocessing module 206 is coupled to the input end of the encoder 201 to perform word segmentation processing on the text to be recognized, and to obtain an initial feature sequence suitable for the data input requirements of the encoder 201. Wherein the initial feature sequence may be an initial feature sequence comprising [CLS] and [SEP]. The [CLS] is used to characterize the beginning of embedding. [SEP] is used between sentences to separate two sentences. The encoder 201 may input the encoding vector corresponding to the [CLS] symbol as the target text feature corresponding to the text to be recognized to the year classification module 202, the month classification module 203, the day classification module 204 and the character entity category detection module 205, in this way, since the encoding vector corresponding to the [CLS] symbol comprises relatively complete semantic information in the text to be recognized, using the encoding vector as the evidence data for classification prediction may improve the accuracy of the classification results effectively.

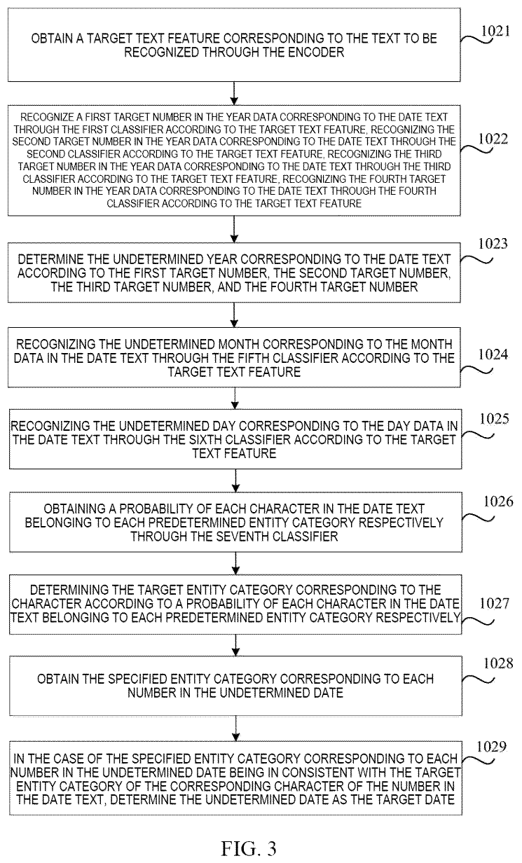

Optionally, the year classification module 202 includes a first classifier 2021, a second classifier 2022, a third classifier 2023 and a fourth classifier 2024, the month classification module 203 includes a fifth classifier, and the day classification module 204 includes a sixth classifier, and the character entity category detection module 205 includes a seventh classifier. FIG. 3 is a flow chart of a date recognition method according to the embodiments shown in FIG. 1. As shown in FIG. 3, The predetermined date recognition model determines the target date in the text to be recognized through the following steps:

step 1021: Obtaining the target text features corresponding to the text to be recognized through the encoder.

Wherein, the target text feature includes contextual semantic information of the date text.

For example, the initial feature sequence input to the encoder may be a feature sequence including [CLS] and [SEP], and the target text feature may be the encoding vector corresponding to the [CLS] symbol in the initial feature sequence output by the encoder.

Step 1022: recognizing, through the first classifier, the first target number in the year data corresponding to the date text according to the target text feature; recognizing, through the second classifier, a second target number in year data corresponding to the date text according to the target text feature; recognizing, through the third classifier, a third target number in year data corresponding to the date text according to the target text feature; recognizing, through the forth classifier, a forth target number in year data corresponding to the date text according to the target test feature.

Wherein, the first classifier may output 1*10-dimensional feature data, which is used to characterize the probability of the first target number in the year data being each number from 0 to 9 respectively; the second classifier may output 1*10-dimensional feature data, which is used to characterize the probability of the second target number in the year data being each number from 0 to 9 respectively; the third classifier may output 1*10-dimensional feature data, which is used to characterize the probability of the third target number in the year data being each number from 0 to 9 respectively; the fourth classifier may output 1*10-dimensional feature data, which is used to characterize the probability of the fourth target number in the year data being each number from 0 to 9 respectively.

Step 1023: determining the undetermined year corresponding to the date text according to the first target number, the second target number, the third target number, and the fourth target number.

For example, if the first classifier recognizes that the first target number is “2”, the second classifier recognizes that the second target number is “0”, and the third classifier recognizes that the third number target number is “1”, and the fourth classifier recognizes that the fourth target number is “8”, then the undetermined year is “2018”.

Step 1024: recognizing, through the fifth classifier, an undetermined month corresponding to month data in the date text according to the target text feature.

Among them, the fifth classifier may output 1*13-dimensional feature data, which is used to characterize the probability of the monthly data being each number from 0 to 12 (13 numbers).

Step 1025: recognizing, through the sixth classifier, an undetermined day corresponding to day data in the date text according to the target text feature.

Wherein, the fifth classifier can output 1*32-dimensional feature data, which is used to characterize the probability of the day data being each number from 0 to 31 (32 numbers).

Step 1026: obtaining, through the seventh classifier, a probability of each character in the date text belonging to each predetermined entity category respectively.

Wherein, the predetermined entity categories may comprise “other”, “year-start”, “year-mid”, “year-end”, “month-start”, “month-end”, “month-single”, “day-Start”, “day-End” and “day-Single”, the data output by the seventh classifier may be L*10-dimensional data, where L is the predetermined length of the encoder input data.

In this step, obtaining, through the seventh classifier, the first probability of each character in the text to be recognized belonging to “year-start” (that is, belonging to the first number in the undetermined year) according to the target text feature, second probability of belonging to “year-mid” (for example, in response to the year being four numbers, it belongs to the second number in the undetermined year or belongs to the third number in the undetermined year), the third probability of belonging to “year-end” (for example, when the year is four numbers that is, the fourth number in the undetermined year), the fourth probability of belonging to “month-single”, the fifth probability of belonging to “month-start”, the sixth probability of belonging to “month-end”, the seventh probability of belonging to “day-single”, the eighth probability of belonging to “day-start”, the ninth probability of belonging to “day-end”, the tenth probability of belonging to “others”.

Step 1027: determining the target entity category corresponding to the character according to the probability of each character in the date text belonging to each predetermined entity category respectively.

In this step, the first to tenth probabilities corresponding to each character may be obtained, and the predetermined entity category corresponding to the maximum value among the first to tenth probabilities may be used as the target entity category.

For example, if the first to tenth probabilities corresponding to the character “2” are 0.1, 0.3, 0.13, 0.15, 0.22, 0.31, 0.5, 0.4, 0.90, 0.3 respectively, then it is determined that the character “2” corresponds to the target entity category “day-end”.

Step 1028: Obtaining the specified entity category corresponding to each number in the undetermined date.

In this step, a possible embodiment is: determining the specified entity category corresponding to the number according to the position of each number in the undetermined date. For example, in response to the format of the undetermined date being “undetermined year-undetermined month-undetermined day”, and the number being the data before the first “-”, then it is determined that the number belongs to the number in the undetermined year. In response to the number being the first number in the number of the undetermined year, it is determined that the specified entity category corresponding to the number is “year-start”. In response to the number being the last number in the number of the undetermined year, it is determined that the specified entity category corresponding to the number is “year-end”. In response to the number belonging to the undetermined the year data, but not being the first number of the undetermined year number, nor being the last number of the undetermined year number, then it is determined that the specified entity category corresponding to this number is “year-mid”. In response to the number being the data between two “-” s, it is determined that the number belongs to a number in an undetermined month. In response to determining that the undetermined month only comprises one digit, it is determined that the specified entity category of the number corresponding to the undetermined month is “month-single”. In response to the undetermined month comprises two digits, if the number is the first number in the undetermined month, then it is determined that the specified entity category corresponding to this number is “month-start”. If the number is the second number of the undetermined month, then it is determined that the specified entity category corresponding to the number is “month-end”. In response to the number being the data after the second “-”, it is determined that the number belongs to the number corresponding to the undetermined day. In response to determining that the undetermined day only comprises one digit, it is determined that the specified entity category of the number corresponding to the undetermined day is “day-single”. In response to determining that the undetermined month comprises two digits, if the number is the first number of the undetermined day, then it is determined that the specified entity category corresponding to the number is “day-start”, if the number is the second number of the undetermined day, then it is determined that the specified entity category corresponding to this number is “day-end”.

Another possible embodiment is: inputting the undetermined date into a predetermined naming entity category recognition model, to cause the predetermined naming entity recognition model to output a specified named entity corresponding to each number in the undetermined date. The specified named entity may be one of “others”, “year-start”, “year-mid”, “year-end”, “month-start”, “month-end”, “month-single”, “day-start”, “day-end” and “day-single”. The predetermined naming entity recognition model may be a neural network model or other machine learning model.

Step 1029: in response to the specified entity category corresponding to each number in the undetermined date being consistent with the target entity category of the corresponding character of the number in the date text, determines the undetermined date as the target date.

For example, in response to the obtained undetermined date being “2018 Jul. 4”, the specified entity category corresponding to the “2” is “year-start”; and the specified entity category corresponding to the “0” is “year-mid”; the specified entity category corresponding to the “1” is “year-mid”; the designated entity category corresponding to the “8” is “year-end”; the specified entity category corresponding to the “-” is “others”; the specified entity category corresponding to “7” is “month-single”; and the designated entity category corresponding to “4” is “day-single”. Similarly, through the method shown in steps 1026 to 1027 above, the target entity category corresponding to each character in 2018 Jul. 4. If the specified entity category corresponding to each character is consistent with the target entity category, the undetermined date is determined as the target date. If there is a specified entity category corresponding to the character being inconsistent with the target entity category, predetermined prompt information is output, the predetermined notification information being used to characterize that the accuracy of the obtained undetermined date is low.

The above technical solution can determine the target date corresponding to the date text according to the target entity category corresponding to each character in the date text and the undetermined date; it is able to recognize the target date in the text to be recognized effectively and accurately. Thereby effectively ensures the recognition rate of the date in the text to be recognized, and also effectively improves the reliability of the date recognition results.

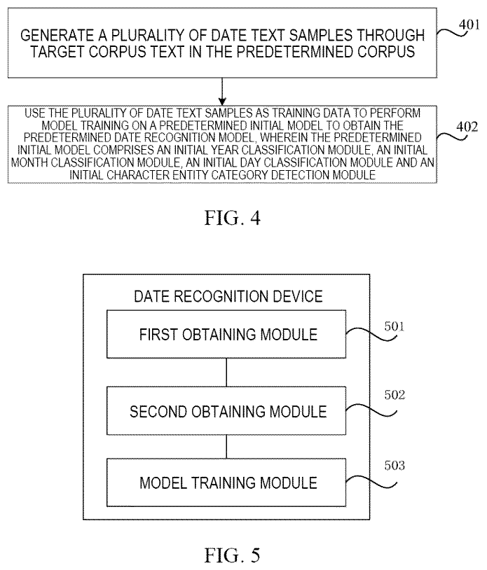

FIG. 4 is a flow chart of a training method of a predetermined date recognition model shown in an exemplary embodiment of the present disclosure; as shown in FIG. 4, the predetermined date recognition model can be trained through:

step 401: generating a plurality of date text samples through target corpus text in the predetermined corpus.

Wherein, the date text sample comprises a date text tag and a naming entity tag of each character in a date text sample.

In this step, the target corpus text can be obtained from the predetermined corpus; obtains a plurality of undetermined text samples corresponding to the target corpus text through performing a date updating operation on the target corpus text, the date updating operation comprising a date adding action and/or a date replacing action; generate the date text sample according to the undetermined text sample.

It should be noted that the date adding action includes a year adding action, a month adding action, and a day adding action. The date replacing action includes a year replacing action, a month replacing action, and a day replacing action. The above-mentioned method is used for the performing a date update operation on the target text to obtain multiple undetermined text samples corresponding to the target corpus text, which may include:

When it is determined that the target corpus text does not include year data, perform the action of adding the year to the target corpus text, and synthesize the added year data with the target corpus text to obtain multiple first text samples; when it is determined that the target corpus text includes year data, perform the year replacement action on the target corpus text to obtain multiple first text samples; when it is determined that the first text sample includes month data and day data, perform the month replacement action on the target corpus text, or perform the day replacement action on the target corpus text to obtain the undetermined text sample; when it is determined that the first text sample does not include month data, perform the month adding action on the target corpus text; the corpus text performs the day adding action, when it is determined that the first text sample does not include day data, and the added month data and day data are synthesized with the target corpus text to obtain the undetermined text sample.

In addition, this step also includes the steps of automatically generating date text labels and naming entity labels for each character in the date text sample, as follows:
When a date is added to the target corpus text, the added first date is used as the date text label; and/or when a date replacement is performed on the target corpus text, the replaced second date is used as the date text label;
obtaining the target position information of each number in the date text label; generating a naming entity category label for each character in the date text sample according to the target position information of each number in the date text label.

It should be noted that when the format of the date text label is “year-month-day”, the target location information may include which number before the first “-” the number belongs to, or which number between two “-” the number belong to, or which number after the second “-” the number belongs to. If the number is the data before the first “-”, determine that the number belongs to the number in the year. If the number is the first number before the first “-”, determine the naming entity label corresponding to the number being “year-start”. If the number is the last number before the first “-”, determine that the naming entity label corresponding to the number is “year-end”. If it is determined that the number belongs to the middle number in the year, that is, the number belongs to the number before the first “-”, but is neither the first number before the first “-” nor the last number before the first “-”, it is determined that the naming entity label corresponding to the number is “year-mid”. If the number is data between two “-”, it is determined that the number belongs to a number in the month. If the month only contains one digit, the naming entity label of the number corresponding to the month is determined to be “month-single”. In the case of determining that the month includes two digits, if the number is the first number between two “-”, then determine that the naming entity label corresponding to the number is “month-start”. If the number is the second number between two “-”, then determine that the naming entity label corresponding to the number is “month-end”. If the number is the data after the second “-”, it is determined that the number belongs to the number corresponding to the day. If it is determined that the day only contains one digit, the naming entity label of the number corresponding to the day is determined to be “day-single”, when it is determined that the day's data includes two digits, if the number is the first number after the second “-”, then it is determined that the naming entity label corresponding to the number is “day-start”, if the number is the second number after the second “-”, then determine that the naming entity label corresponding to the number is “day-end”. In addition, in addition to the year number, month number and day number in the date text sample, naming entity tags for characters other than characters corresponding to year, month and day numbers are determined to be “other”.

Step 402: using the plurality of date text samples as training data to perform model training on a predetermined initial model to obtain the predetermined date recognition model, wherein the predetermined initial model comprises an initial year classification module, an initial month classification module, an initial day classification module and an initial character entity category detection module.

Wherein, the predetermined initial model may include an initial BERT encoder. The initial year classification module, the initial month classification module, the initial day classification module and the initial character entity category detection module are all coupled to the initial BERT encoder. During the model training process, model training can be performed using cross-entropy as the loss function.

The above technical solution can automatically synthesize multiple date text samples as training data, which can effectively avoid the problems in related technologies that the training data is difficult to obtain, the labeling efficiency being low, and the labeling process is time-consuming and laborious. At the same time, because it includes the initial year classification module, the initial month classification module, the initial day classification module and the initial character entity category detection module for performing the date recognition, so it can effectively improve the convergence speed of the predetermined date recognition model, improving the model training efficiency, and can also effectively ensure the generalization capability of the predetermined date recognition model obtained by training, and the accuracy of the date recognition results.

FIG. 5 is a block diagram of a date recognition device illustrating an exemplary embodiment of the present disclosure. As shown in FIG. 5, the device may include:
the first obtaining module 501, configured to obtain text to be recognized, the text to be recognized includes date text;
the second obtaining module 502, configured to input the text to be recognized into a predetermined date recognition model to obtain the target date output through the predetermined date recognition model;
wherein, the predetermined date recognition model is used to recognize a undetermined date corresponding to the date text, obtaining a target entity category corresponding to each character in the date text, determining a target date corresponding to the date text according to a target entity category corresponding to each character in the date text and the undetermined date, the target entity category being used to characterize whether the character being a specified character related to a date number, and in response to the character being a specified character related to a date number, the character corresponding to position information of a number in a date.

The above technical solution can determine the target date corresponding to the date text according to the target entity category corresponding to each character in the date text and the undetermined date; it is able to recognize the target date in the text to be recognized effectively and accurately. Thereby effectively ensures the recognition rate of the date in the text to be recognized, and also effectively improves the reliability of the date recognition results.

Optionally, the predetermined date recognition model is used for: obtaining the specified entity category corresponding to each number in the undetermined date; in response to the specified entity category corresponding to each number in the undetermined date being consistent with the target entity category of the character corresponding to the number in the text of the date, determining the undetermined date as the target date.

Optionally, the undetermined date includes an undetermined year, an undetermined month, and an undetermined day. The predetermined date recognition model includes an encoder, and a year classification module, a month classification module, a day classification module and a character entity category detection module coupled to the encoder.

The year classification module is used to recognize the undetermined year in the date text. The year classification module includes multiple classifiers, and different classifiers are used to recognize numbers at different positions in the undetermined year;

The month classification module is used to recognize the undetermined month in the date text.

The day classification module is used to recognize the undetermined day in the date text.

The character entity category detection module is used to obtain the target entity category corresponding to each character in the date text.

Optionally, the year classification module includes a first classifier, a second classifier, a third classifier and a fourth classifier, the month classification module including a fifth classifier, and the day classification module includes a sixth classifier, the character entity category detection module including a seventh classifier, and the predetermined date recognition model is used for:
obtain the target text feature corresponding to the text to be recognized through the encoder, the target text feature including contextual semantic information of the date text;
the first classifier recognizing the first target number in the year data corresponding to the date text according to the target text feature, and the second classifier recognizing the second target number in the year data corresponding to the date text according to the target text feature, the third classifier recognizing the third target number in the year data corresponding to the date text according to the target text feature, and the fourth classifier recognizing the fourth target number in the year data corresponding to the date text according to the target text feature;
determining the undetermined year corresponding to the date text according to the first target number, the second target number, the third target number, and the fourth target number;
recognizing, through the fifth classifier, an undetermined month corresponding to month data in the date text according to the target text feature;
recognizing, through the sixth classifier, an undetermined day corresponding to day data in the date text according to the target text feature;
obtaining, through the seventh classifier, a probability of each character in the date text belonging to each predetermined entity category respectively;
determining the target entity category corresponding to the character according to a probability of each character in the date text belonging to each predetermined entity category respectively.

Optionally, the device also includes a model training module 503, which is used for:
generating a plurality of date text samples through target corpus text in the predetermined corpus, where the date text sample comprises a date text tag and a naming entity tag of each character in a date text sample;
using the plurality of date text samples as training data to perform model training on a predetermined initial model to obtain the predetermined date recognition model, wherein the predetermined initial model comprises an initial year classification module, an initial month classification module, an initial day classification module and an initial character entity category detection module.

Optionally, the model training module 503 is used for: obtaining the target corpus text from the predetermined corpus; obtaining a plurality of undetermined text samples corresponding to the target corpus text through performing a date updating operation on the target corpus text, the date updating operation comprising a date adding action and/or a date replacing action; generating the date text sample according to the undetermined text sample.

Optionally, the model training module 503 is used for: obtaining predetermined interference text; adding the predetermined interference text to the undetermined text sample; after adding the predetermined interference text, performing a simulated character adhesion operation on the undetermined text sample to obtain the date text sample.

Optionally, the model training module 503 is also used for: in response to performing a date adding action to the target corpus text, using an added first date as the date text label; and/or in response to performing a date replacing action on the target corpus text, using a replaced second date as the date text label.

Optionally, the model training module 503 is also used for: obtaining target position information of each number in the date text label; generating a naming entity category label of each character in the date text sample according to the target location information of each number in the date text label.

The above technical solution can automatically synthesize multiple date text samples as training data, which can effectively avoid the problems in related technologies that the training data is difficult to obtain, the labeling efficiency being low, and the labeling process is time-consuming and laborious. At the same time, because it includes the initial year classification module, the initial month classification module, the initial day classification module and the initial character entity category detection module for performing the date recognition, so it can effectively improve the convergence speed of the predetermined date recognition model, improving the model training efficiency, and can also effectively ensure the generalization capability of the predetermined date recognition model obtained by training, and the accuracy of the date recognition results.

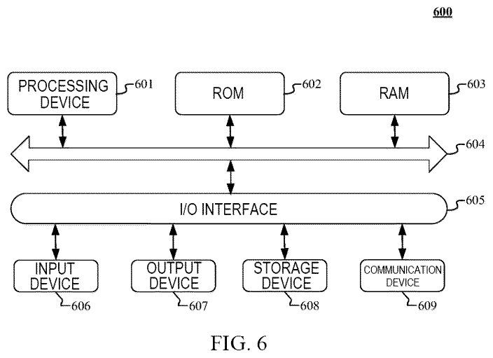

Referring now to FIG. 6, a schematic structural diagram of an electronic device 600 suitable for implementing embodiments of the present disclosure is shown. Terminal devices in embodiments of the present disclosure may include, but are not limited to, mobile phones, notebook computers, digital broadcast receivers, PDAs (personal digital assistants), PADs (tablet computers), PMP (portable multimedia players), vehicle-mounted terminals (such as vehicle-mounted Mobile terminals such as navigation terminals) and fixed terminals such as digital TVs, desktop computers, etc. The electronic device shown in FIG. 6 is only an example and should not impose any limitations on the functions and scope of use of the embodiments of the present disclosure.

As shown in FIG. 6, the electronic device 600 may include a processing device 601 (eg, central processing unit, graphics processor, etc.), which may execute various appropriate actions and processes according to a program stored in a read-only memory (ROM) 602 or a program loaded from a storage device 608 to a random access memory (RAM). In the RAM 603, various programs and data required for the operation of the electronic device 600 are also stored. The processing device 601, ROM 602 and RAM 603 are connected to each other via a bus 604. An input/output (I/O) interface 605 is also connected to bus 604.

Generally, the following devices may be connected to the I/O interface 605: input devices 606 including, for example, a touch screen, touch pad, keyboard, mouse, camera, microphone, accelerometer, gyroscope, etc.; output device 607 including, for example, a liquid crystal display (LCD), speaker, vibration; a storage device 608 including a magnetic tape, a hard disk, etc.; and a communication device 609. Communication device 609 may allow electronic device 600 to communicate wirelessly or wiredly with other devices to exchange data. Although FIG. 6 illustrates electronic device 600 with various means, it should be understood that implementation or availability of all illustrated means is not required. More or fewer means may alternatively be implemented or provided.

In particular, according to embodiments of the present disclosure, the processes described above with reference to the flowcharts may be implemented as computer software programs. For example, embodiments of the present disclosure include a computer program product including a computer program carried on a non-transitory computer-readable medium, the computer program containing program code for performing the method illustrated in the flowchart. In such embodiments, the computer program may be downloaded and installed from the network via the communication device 609, or installed from the storage device 608, or installed from the ROM 602. When the computer program is executed by the processing device 601, the above-mentioned functions defined in the method of embodiments of the present disclosure are performed.

It should be noted that the computer-readable medium mentioned above in the present disclosure may be a computer-readable signal medium or a computer-readable storage medium, or any combination of the above two. The computer-readable storage medium may be, for example, but not limited to, an electrical, magnetic, optical, electromagnetic, infrared, or semiconductor system, device or apparatus, or any combination thereof. More specific examples of computer readable storage media may include, but are not limited to: an electrical connection having one or more wires, a portable computer disk, a hard drive, random access memory (RAM), read only memory (ROM), removable memory programmable read-only memory (EPROM or flash memory), optical fiber, portable compact disk read-only memory (CD-ROM), optical storage device, magnetic storage device, or any suitable combination of the above. In this disclosure, a computer-readable storage medium may be any tangible medium that contains or stores a program for use by or in connection with an instruction execution system, apparatus, or device. In the present disclosure, a computer-readable signal medium may include a data signal propagated in baseband or as part of a carrier wave, carrying computer-readable program code therein. Such propagated data signals may take many forms, including but not limited to electromagnetic signals, optical signals, or any suitable combination of the above. A computer-readable signal medium may also be any computer-readable medium other than a computer-readable storage medium that can send, propagate, or transmit a program for use by or in connection with an instruction execution system, apparatus, or device. Program code embodied on a computer-readable medium may be transmitted using any suitable medium, including but not limited to: wire, optical fiber cable, RF (radio frequency), etc., or any suitable combination of the foregoing.

In some embodiments, communication can be performed using any currently known or future developed network protocol, such as HTTP (HyperText Transfer Protocol), and can communicate with digital data in any form or medium (e.g., communication network) interconnection. Examples of communications networks include local area networks (“LAN”), wide area networks (“WAN”), the Internet (e.g., the Internet), and end-to-end networks (e.g., ad hoc end-to-end networks), as well as any currently known or future developed network.

The above-mentioned computer-readable medium may be included in the above-mentioned electronic device; it may also exist independently without being assembled into the electronic device.

The computer-readable medium carries one or more programs. When the one or more programs are executed by the electronic device, the electronic device: obtains text to be recognized, and the text to be recognized includes date text; inputs the text to be recognized into a predetermined date recognition model to obtain a target date output by the predetermined date recognition model; wherein, the predetermined date recognition model is used to: recognize an undetermined date corresponding to the date text; obtain a target entity category corresponding to each character in the date text; determine a target date corresponding to the date text according to a target entity category corresponding to each of character in the date text and the undetermined date, the target entity category being used to characterize whether the character is a specified character related to a date number; and in response to the character being a specified character related to a date number, the character corresponding to position information of the number in the date.

Computer program code for performing the operations of the present disclosure may be written in one or more programming languages, including but not limited to object-oriented programming languages-such as Java, Smalltalk, C++, and includes conventional procedural programming languages such as “C” or similar programming languages. The program code may execute entirely on the user's computer, partly on the user's computer, as a stand-alone software package, partly on the user's computer and partly on a remote computer or entirely on the remote computer or server. In situations involving remote computers, the remote computer can be connected to the user's computer through any kind of network, including a local area network (LAN) or a wide area network (WAN), or it can be connected to an external computer (such as an using an Internet service provider and connected via the Internet).

The flowcharts and block diagrams in the accompanying drawings illustrate the architecture, functionality, and operations of systems, methods, and computer program products that may be implemented in accordance with various embodiments of the present disclosure. In this regard, each block in the flowchart or block diagram may represent a module, segment, or portion of code that contains one or more logic functions that implement the specified executable instructions. It should also be noted that, in some alternative implementations, the functions noted in the block may occur out of the order noted in the figures. For example, two blocks shown one after another may actually execute substantially in parallel, or they may sometimes execute in the reverse order, depending on the functionality involved. It will also be noted that each block of the block diagram and/or flowchart illustration, and combinations of blocks in the block diagram and/or flowchart illustration, can be implemented by special purpose hardware-based systems that perform the specified functions or operations, or can be implemented using a combination of specialized hardware and computer instructions.

The modules involved in the embodiments described in this disclosure can be implemented in software or hardware. The name of the module does not constitute a limitation on the module itself under certain circumstances. For example, the first obtaining module can also be described as “a module that obtains text to be recognized, and the text to be recognized includes date text.”

The functions described above herein may be performed, at least in part, by one or more hardware logic components. For example, and without limitation, exemplary types of hardware logic components that may be used include: Field Programmable Gate Arrays (FPGAs), Application Specific Integrated Circuits (ASICs), Application Specific Standard Products (ASSPs), Systems on Chips (SOCs), Complex Programmable Logical device (CPLD) and so on.

In the context of this disclosure, a machine-readable medium may be a tangible medium that may contain or store a program for use by or in connection with an instruction execution system, apparatus, or device. The machine-readable medium may be a machine-readable signal medium or a machine-readable storage medium. machine-readable media may include, but are not limited to, electronic, magnetic, optical, electromagnetic, infrared, or semiconductor systems, devices or devices, or any suitable combination of the foregoing. More specific examples of machine-readable storage media would include one or more wires based electrical connection, laptop disk, hard drive, random access memory (RAM), read only memory (ROM), erasable programmable read only memory (EPROM or flash memory), optical fiber, portable compact disk read-only memory (CD-ROM), optical storage device, magnetic storage device, or any suitable combination of the above.

According to one or more embodiments of the present disclosure, Example 1 provides a date recognition method, the method includes:
obtaining text to be recognized, the text to be recognized comprising date text;
inputting the text to be recognized into a predetermined date recognition model to obtain a target date output by the predetermined date recognition model;
wherein, the predetermined date recognition model is used to: recognize an undetermined date corresponding to the date text; obtain a target entity category corresponding to each character in the date text; determine a target date corresponding to the date text according to a target entity category corresponding to each of character in the date text and the undetermined date, the target entity category being used to characterize whether the character is a specified character related to a date number; and in response to the character being a specified character related to a date number, the character corresponding to position information of the number in the date.

According to one or more embodiments of the present disclosure, Example 2 provides the method of Example 1, which determines the target date corresponding to the date text according to the target entity category corresponding to each character in the date text and the undetermined date, including:
obtaining a specified entity category corresponding to each number in the undetermined date;
in response to the specified entity category corresponding to each number in the undetermined date being in consistent with the target entity category of a character corresponding to the number in the date text, determining the undetermined date as the target date.

According to one or more embodiments of the present disclosure, Example 3 provides the method of Example 1, the undetermined date comprises an undetermined year, an undetermined month and an undetermined day, the predetermined date recognition model comprising an encoder and a year classification module, a month classification module, a day classification module and a character entity category detection module coupled with the encoder;

the year classification module being used to recognize the undetermined year in the date text, the year classification module comprising a plurality of classifiers, different classifiers being used to recognize numbers at different positions in the undetermined year;

the month classification module being used to recognize the undetermined month in the date text;

the day classification module being used to recognize the undetermined day in the date text;

the character entity category detection module being used to obtain the target entity category corresponding to each character in the date text.

According to one or more embodiments of the present disclosure, Example 4 provides the method of Example 3, wherein the year classification module comprises a first classifier, a second classifier, a third classifier and a fourth classifier, the month classification module comprising a fifth classifier, the day classification module comprising a sixth classifier, the character entity category detection module comprising a seventh classifier, the predetermined date recognition model being used for:
obtaining a target text feature corresponding to the text to be recognized through the encoder, where the target text feature comprises contextual semantic information of the date text;
recognizing, through the first classifier, a first target number in year data corresponding to the date text according to the target text feature; recognizing, through the second classifier, a second target number in year data corresponding to the date text according to the target text feature; recognizing, through the third classifier, a third target number in year data corresponding to the date text according to the target text feature; recognizing, through the forth classifier, a forth target number in year data corresponding to the date text according to the target test feature;
determining the undetermined year corresponding to the date text according to the first target number, the second target number, the third target number and the fourth target number;
recognizing, through the fifth classifier, an undetermined month corresponding to month data in the date text according to the target text feature;
recognizing, through the sixth classifier, an undetermined day corresponding to day data in the date text according to the target text feature;
obtaining, through the seventh classifier, a probability of each character in the date text belonging to each predetermined entity category respectively;
determining the target entity category corresponding to the character according to a probability of each character in the date text belonging to each predetermined entity category respectively.

According to one or more embodiments of the present disclosure, Example 5 provides the method of Example 1. The predetermined date recognition model is trained through:
generating a plurality of date text samples through target corpus text in the predetermined corpus, where the date text sample comprises a date text tag and a naming entity tag of each character in a date text sample;
using the plurality of date text samples as training data to perform model training on a predetermined initial model to obtain the predetermined date recognition model, wherein the predetermined initial model comprises an initial year classification module, an initial month classification module, an initial day classification module and an initial character entity category detection module.

According to one or more embodiments of the present disclosure, Example 6 provides the method of Example 5, wherein generating a plurality of date text samples according to a target corpus text in the predetermined corpus comprises:
obtaining the target corpus text from the predetermined corpus;
obtaining a plurality of undetermined text samples corresponding to the target corpus text through performing a date updating operation on the target corpus text, the date updating operation comprising a date adding action and/or a date replacing action;
generating the date text sample according to the undetermined text sample.

According to one or more embodiments of the present disclosure, Example 7 provides the method of Example 6, wherein generating the date text sample according to the undetermined text sample comprises:
obtaining predetermined interference text;
adding the predetermined interference text to the undetermined text sample;
after adding the predetermined interference text, performing a simulated character adhesion operation on the undetermined text sample to obtain the date text sample.

According to one or more embodiments of the present disclosure, Example 8 provides the method of Example 6, wherein generating a plurality of date text samples according to target corpus text in the predetermined corpus further comprises:
in response to performing a date adding action to the target corpus text, using an added first date as the date text label; and/or,
in response to performing a date replacing action on the target corpus text, using a replaced second date as the date text label.

According to one or more embodiments of the present disclosure, Example 9 provides the method of Example 6, wherein generating a plurality of date text samples according to target corpus text in the predetermined corpus further comprises:
obtaining target position information of each number in the date text label;
generating a naming entity category label of each character in the date text sample according to the target location information of each number in the date text label.

According to one or more embodiments of the present disclosure, Example 10 provides a date recognition device, wherein the device comprises:
a first obtaining module, configured to obtain text to be recognized, the text to be recognized comprising date text;
a second obtaining module, configured to input the text to be recognized into a predetermined date recognition model to obtain a target date output through the predetermined date recognition model;
wherein, the predetermined date recognition model is used to recognize a undetermined date corresponding to the date text, obtaining a target entity category corresponding to each character in the date text, determining a target date corresponding to the date text according to a target entity category corresponding to each character in the date text and the undetermined date, the target entity category being used to characterize whether the character being a specified character related to a date number, and in response to the character being a specified character related to a date number, the character corresponding to position information of a number in a date.

According to one or more embodiments of the present disclosure, Example 11 provides a computer-readable medium having a computer program stored thereon, wherein steps of the method described in any one of Examples 1-9 are implemented in response to the program being executed by a processing device.

According to one or more embodiments of the present disclosure, Example 12 provides an electronic device, including:
a storage device having a computer program stored thereon;
a processing device, configured to execute the computer program in the storage device to implement steps of the method in any one of Examples 1-9.

The above description is only a description of the preferred embodiments of the present disclosure and the technical principles used. Those skilled in the art should understand that the disclosure scope involved in the present disclosure is not limited to technical solutions composed of specific combinations of the above technical features, but should also cover solutions composed of the above technical features or without departing from the above disclosed concept. Other technical solutions formed by any combination of equivalent features. For example, a technical solution is formed by replacing the above features with technical features with similar functions disclosed in this disclosure (but not limited to).

Furthermore, although operations are depicted in a specific order, this should not be understood as requiring that these operations be performed in the specific order shown or performed in a sequential order. Under certain circumstances, multitasking and parallel processing may be advantageous. Likewise, although several specific implementation details are included in the above discussion, these should not be construed as limiting the scope of the present disclosure. Certain features described in the context of individual embodiments may also be implemented in combination in a single embodiment. Conversely, various features that are described in the context of a single embodiment can also be implemented in multiple embodiments individually or in any suitable sub-combination.

Although the present subject matter has been described in language specific to structural features and/or methodological logical acts, it should be understood that the subject matter defined in the accompanying claims is not necessarily limited to the specific features or acts described above. Rather, the specific features and actions described above are merely example forms of implementing claims. Regarding the devices in the above embodiments, the specific manner in which each module performs operations has been described in detail in the embodiments related to the method, and will not be elaborated here.

1. A date recognition method, comprising:
obtaining text to be recognized, the text to be recognized comprising date text; and
inputting the text to be recognized into a predetermined date recognition model to obtain a target date output by the predetermined date recognition model;
wherein, the predetermined date recognition model is used to: recognize an undetermined date corresponding to the date text; obtain a target entity category corresponding to each character in the date text; determine a target date corresponding to the date text according to a target entity category corresponding to each of character in the date text and the undetermined date, the target entity category being used to characterize whether the character is a specified character related to a date number; and in response to the character being a specified character related to a date number, the character corresponding to position information of the number in the date.

2. The method of claim 1, wherein determining the target date corresponding to the date text according to a target entity category corresponding to each character in the date text comprises:
obtaining a specified entity category corresponding to each number in the undetermined date; and
in response to the specified entity category corresponding to each number in the undetermined date being in consistent with the target entity category of a character corresponding to the number in the date text, determining the undetermined date as the target date.

3. The method of claim 1, wherein the undetermined date comprises an undetermined year, an undetermined month and an undetermined day, the predetermined date recognition model comprising an encoder and a year classification module, a month classification module, a day classification module and a character entity category detection module coupled with the encoder;
the year classification module being used to recognize the undetermined year in the date text, the year classification module comprising a plurality of classifiers, different classifiers being used to recognize numbers at different positions in the undetermined year;
the month classification module being used to recognize the undetermined month in the date text;
the day classification module being used to recognize the undetermined day in the date text;
the character entity category detection module being used to obtain the target entity category corresponding to each character in the date text.

4. The method of claim 3, wherein the year classification module comprises a first classifier, a second classifier, a third classifier and a fourth classifier, the month classification module comprising a fifth classifier, the day classification module comprising a sixth classifier, the character entity category detection module comprising a seventh classifier, the predetermined date recognition model being used for obtaining a target text feature corresponding to the text to be recognized through the encoder, where the target text feature comprises contextual semantic information of the date text;
recognizing, through the first classifier, a first target number in year data corresponding to the date text according to the target text feature; recognizing, through the second classifier, a second target number in year data corresponding to the date text according to the target text feature;
recognizing, through the third classifier, a third target number in year data corresponding to the date text according to the target text feature; recognizing, through the forth classifier, a forth target number in year data corresponding to the date text according to the target test feature;
determining the undetermined year corresponding to the date text according to the first target number, the second target number, the third target number and the fourth target number, recognizing, through the fifth classifier, an undetermined month corresponding to month data in the date text according to the target text feature;
recognizing, through the sixth classifier, an undetermined day corresponding to day data in the date text according to the target text feature;
obtaining, through the seventh classifier, a probability of each character in the date text belonging to each predetermined entity category respectively; and
determining the target entity category corresponding to the character according to a probability of each character in the date text belonging to each predetermined entity category respectively.

5. The method of claim 1, wherein the predetermined date recognition model is trained through:
generating a plurality of date text samples through target corpus text in the predetermined corpus, where the date text sample comprises a date text tag and a naming entity tag of each character in a date text sample; and
using the plurality of date text samples as training data to perform model training on a predetermined initial model to obtain the predetermined date recognition model, wherein the predetermined initial model comprises an initial year classification module, an initial month classification module, an initial day classification module and an initial character entity category detection module.

6. The method of claim 5, wherein generating a plurality of date text samples according to a target corpus text in the predetermined corpus comprises:
obtaining the target corpus text from the predetermined corpus;
obtaining a plurality of undetermined text samples corresponding to the target corpus text through performing a date updating operation on the target corpus text, the date updating operation comprising a date adding action and/or a date replacing action; and
generating the date text sample according to the undetermined text sample.

7. The method of claim 6, wherein generating the date text sample according to the undetermined text sample comprises:
obtaining predetermined interference text;
adding the predetermined interference text to the undetermined text sample; and
after adding the predetermined interference text, performing a simulated character adhesion operation on the undetermined text sample to obtain the date text sample.

8. The method of claim 6, wherein generating a plurality of date text samples according to target corpus text in the predetermined corpus further comprises:
in response to performing a date adding action to the target corpus text, using an added first date as the date text label; and/or
in response to performing a date replacing action on the target corpus text, using a replaced second date as the date text label.

9. The method of claim 6, wherein generating a plurality of date text samples according to target corpus text in the predetermined corpus further comprises:
obtaining target position information of each number in the date text label; and
generating a naming entity category label of each character in the date text sample according to the target location information of each number in the date text label.

10. (canceled)

11. A non-transitory computer-readable medium having a computer program stored thereon, wherein, in response to the program being executed by a processing device, implements steps of a method comprising:
obtaining text to be recognized, the text to be recognized comprising date text; and
inputting the text to be recognized into a predetermined date recognition model to obtain a target date output by the predetermined date recognition model;
wherein, the predetermined date recognition model is used to: recognize an undetermined date corresponding to the date text; obtain a target entity category corresponding to each character in the date text; determine a target date corresponding to the date text according to a target entity category corresponding to each of character in the date text and the undetermined date, the target entity category being used to characterize whether the character is a specified character related to a date number; and in response to the character being a specified character related to a date number, the character corresponding to position information of the number in the date.

12. An electronic device, comprising:
a storage device having a computer program stored thereon;
a processing device, configured to execute the computer program in the storage device to implement steps of a method comprising:
obtaining text to be recognized, the text to be recognized comprising date text; and
inputting the text to be recognized into a predetermined date recognition model to obtain a target date output by the predetermined date recognition model;
wherein, the predetermined date recognition model is used to: recognize an undetermined date corresponding to the date text, obtain a target entity category corresponding to each character in the data text; determine a target date corresponding to the date text according to a target entity category corresponding to each of character in the date text and the undetermined date, the target entity category being used to characterize whether the character is a specified character related to a date number; and in response to the character being a specified character related to a date number, the character corresponding to position information of the number in the date.

13. A non-transitory computer-readable medium of claim 10, wherein determining the target date corresponding to the date text according to a target entity category corresponding to each character in the date text comprises:
obtaining a specified entity category corresponding to each number in the undetermined date; and
in response to the specified entity category corresponding to each number in the undetermined date being in consistent with the target entity category of a character corresponding to the number in the date text, determining the undetermined date as the target date.

14. The electronic device of claim 12, wherein determining the target date corresponding to the date text according to a target entity category corresponding to each character in the date text comprises:
obtaining a specified entity category corresponding to each number in the undetermined date; and
in response to the specified entity category corresponding to each number in the undetermined date being in consistent with the target entity category of a character corresponding to the number in the date txt, determining the undetermined date as the target date.

15. The electronic device of claim 12, wherein the undetermined date comprises an undetermined year, an undetermined month and an undetermined day, the predetermined date recognition model comprising an encoder and a year classification module, a month classification module, a day classification module and a character entity category detection module coupled with the encoder;
the year classification module being used to recognize the undetermined year in the date text, the year classification module comprising a plurality of classifiers, different classifiers being used to recognize numbers at different positions in the undetermined year;
the month classification module being used to recognize the undetermined month in the date text;
the day classification module being used to recognize the undetermined day in the date text;
the character entity category detection module being used to obtain the target entity category corresponding to each character in the date text.

16. The electronic device of claim 14, wherein the year classification module comprises a first classifier, a second classifier, a third classifier and a fourth classifier, the month classification module comprising a fifth classifier, the day classification module comprising a sixth classifier, the character entity category detection module comprising a seventh classifier, the predetermined date recognition model being used for:
obtaining a target text feature corresponding to the text to be recognized through the encoder, where the target text feature comprises contextual semantic information of the date text;
recognizing, through the first classifier, a first target number in year data corresponding to the date text according to the target text feature; recognizing, through the second classifier, a second target number in year data corresponding to the date text according to the target text feature; recognizing, through the third classifier, a third target number in year data corresponding to the date text according to the target text feature; recognizing, through the forth classifier, a forth target number in year data corresponding to the date text according to the target test feature;
determining the undetermined year corresponding to the date text according to the first target number, the second target number, the third target number and the fourth target number;
recognizing, through the fifth classifier, an undetermined month corresponding to month data in the date text according to the target text feature;
recognizing, through the sixth classifier, an undetermined day corresponding to day data in the date text according to the target text feature;
obtaining, through the seventh classifier, a probability of each character in the date text belonging to each predetermined entity category respectively; and
determining the target entity category corresponding to the character according to a probability of each character in the date text belonging to each predetermined entity category respectively.

17. The electronic device of claim 12, wherein the predetermined date recognition model is trained through:
generating a plurality of date text samples through target corpus text in the predetermined corpus, where the date text sample comprises a date text tag and a naming entity tag of each character in a date text sample; and
using the plurality of date text samples as training data to perform model training on a predetermined initial model to obtain the predetermined date recognition model, wherein the predetermined initial model comprises an initial year classification module, an initial month classification module, an initial day classification module and an initial character entity category detection module.

18. The electronic device of claim 17, wherein generating a plurality of date text samples according to a target corpus text in the predetermined corpus comprises:
obtaining the target corpus text from the predetermined corpus;
obtaining a plurality of undetermined text samples corresponding to the target corpus text through performing a date updating operation on the target corpus text, the date updating operation comprising a date adding action and/or a date replacing action; and
generating the date text sample according to the undetermined text sample.

19. The electronic device of claim 18, wherein generating the date text sample according to the undetermined text sample comprises:
obtaining predetermined interference text;
adding the predetermined interference text to the undetermined text sample; and
after adding the predetermined interference text, performing a simulated character adhesion operation on the undetermined text sample to obtain the date text sample.

20. The electronic device of claim 18, wherein generating a plurality of date text samples according to target corpus text in the predetermined corpus further comprises:
in response to performing a date adding action to the target corpus text, using an added first date as the date text label; and/or
in response to performing a date replacing action on the target corpus text, using a replaced second date as the date text label.

21. The electronic device of claim 18, wherein generating a plurality of date text samples according to target corpus text in the predetermined corpus further comprises:
obtaining target position information of each number in the date text label; and
generating a naming entity category label of each character in the date text sample according to the target location information of each number in the date text label.
